(19) United States
(12) Patent Application Publication
(10) Pub. No.: US 2007/0229045 A1
(43) Pub. Date: Oct. 4, 2007

(54) Power control device for controlling supply of electric power from a power source to load terminals

(76) Inventor: Chen-Sheng Wu, Tainan City (TW)

Correspondence Address: FROMMER LAWRENCE & HAUG, 745 FIFTH AVENUE- 10TH FL., NEW YORK, NY, 10151, US

(21) Appl. No.: 11/396,105

(22) Filed: Mar. 31, 2006

(51) Int. Cl. G05F 1/00

(52) U.S. Cl. 323/282

(57) ABSTRACT

A power control device is adapted for controlling supply of electric power from a power source to load terminals in various control modes. A first control unit of a first circuit module receives the electric power from the power source, and an input signal generated by an operating unit and associated with a corresponding control mode so as to generate an encoded output signal. A second control unit of a second circuit module receives the encoded output signal from the first control unit, and supplies a power portion of the encoded output signal equivalent to the electric power to a combination of the load terminals that corresponds to a distinct control code portion of the encoded output signal corresponding to the input signal.

### BACKGROUND OF THE INVENTION

1. Field of the Invention

The invention relates to a power control device, more particularly to a power control device for controlling supply of electric power from a power source to a plurality of load terminals.

2. Description of the Related Art

Referring to FIG. 1, a conventional switch control device 21 is applied to a lamp device 22 for controlling supply of electric power from an AC power source 25 to the lamp device 22 in various control modes. The lamp device 22 can be mounted on a ceiling of a room (not shown), and includes five lamps 221. The conventional switch control device 21 includes a switch unit 211 that can be mounted on a wall of a room and that is connected electrically to the power source 25, and a controller 212 that can be mounted on or installed in the lamp device 22 and that interconnects electrically the switch unit 211 and the lamp device 22. The switch unit 211 can be switched between an ON-state, where the electric power from the power source 25 can be supplied to the lamp device 22 under control of the controller 212, and an OFF-state, where no electric power is supplied to the lamp device 22. The controller 212 controls the lamp device 22 in each of the control modes in response to a detected number of ON/OFF switching cycles of the switch unit 211. For example, in a first one of the control modes, the switch unit 211 is first operated to the ON-state such that only one of the lamps 221 of the lamp device 22 is activated. In a second one of the control modes, the switch unit 221 is operated in the ON-state, OFF-state and ON-state in sequence such that three of the lamps 221 of the lamp device 22 are activated. In a third one of the control modes, the switch unit 221 is operated in the ON-state, OFF-state, ON-state, OFF-state and ON-state in sequence such that all of the lamps 221 of the lamp device 22 are activated.

Therefore, for the conventional switch control device 21, frequent operations of the switch unit 211 cannot be avoided, thereby resulting in a relatively short service life. Furthermore, repeated ON/OFF switching of the switch unit 211 adversely affects the service life of the lamps 221.

### SUMMARY OF THE INVENTION

Therefore, the object of the present invention is to provide a power control device for controlling supply of electric power from a power source to a plurality of load terminals that can eliminate the aforesaid drawbacks of the prior art.

According to one aspect of the present invention, there is provided a power control device for controlling supply of electric power from a power source to a plurality of load terminals in various control modes. The power control device comprises:

a first circuit module including
an operating unit including a plurality of operating keys, each of which is operable so as to generate an input signal associated with a corresponding one of the control modes, and
a first control unit adapted to be connected electrically to the power source for receiving the electric power therefrom, and connected electrically to the operating unit for receiving the input signal therefrom so as to generate an encoded output signal that includes a distinct control code portion corresponding to the input signal, and a power portion equivalent to the electric power from the power source; and

a second circuit module including
an output end unit adapted to be connected electrically to the load terminals, and
a second control unit connected electrically to the first control unit of the first circuit module and the output end unit, the second control unit receiving the encoded output signal from the first control unit of the first circuit module and supplying the power portion of the encoded output signal via the output end unit to a combination of the load terminals that corresponds to the control code portion of the encoded output signal.

According to another aspect of the present invention, there is provided a circuit module for generating distinct encoded output signals to control supply of electric power from a power source to a plurality of load terminals in various control modes. The circuit module comprises:

a hollow housing;

an operating unit mounted on the housing and having a plurality of operating keys, each of which is operable so as to generate an input signal associated with a corresponding one of the control modes; and

a control unit mounted in the housing, adapted to be connected electrically to the power source for receiving the electric power therefrom, and connected electrically to the operating unit for receiving the input signal therefrom so as to generate a corresponding one of the encoded output signals that includes a distinct control code portion corresponding to the input signal, and a power portion equivalent to the electric power from the power source.

According to a further aspect of the present invention, there is provided a circuit module for controlling supply of electric power to a plurality of load terminals in various control modes and in response to an encoded output signal that is received thereby and that has a distinct control code portion associated with a corresponding one of the control modes, and a power portion equivalent to the electric power. The circuit module comprises:

a hollow housing;

an output end unit mounted on the housing and adapted to be connected electrically to the load terminals; and

a control unit mounted in the housing, connected electrically to the output end unit, adapted for receiving the encoded output signal, and supplying the power portion of the encoded output signal via the output end unit to a combination of the load terminals that corresponds to the control code portion of the encoded output signal.

### BRIEF DESCRIPTION OF THE DRAWINGS

Other features and advantages of the present invention will become apparent in the following de tailed description of the preferred embodiment with reference to the accompanying drawings, of which:

FIG. 1 is a schematic circuit diagram showing a conventional power control device for controlling supply of electric power to a plurality of loads;

FIG. 2 is a schematic circuit diagram showing the preferred embodiment of a power control device according to the present invention;

FIG. 3 is a schematic view illustrating the preferred embodiment installed in a building;

FIG. 4 is a schematic circuit block diagram showing a first circuit unit of the preferred embodiment;

FIG. 5 is a schematic electrical circuit diagram showing the first circuit unit of the preferred embodiment;

FIGS. 6a to 6c are plots illustrating various encoded output signals S1, S2, S3 generated by the first circuit unit of the preferred embodiment;

FIG. 7 is a schematic circuit block diagram showing a second circuit unit of the preferred embodiment; and

FIG. 8 is a schematic electrical circuit diagram showing the second circuit unit of the preferred embodiment.

### DETAILED DESCRIPTION OF THE PREFERRED EMBODIMENT

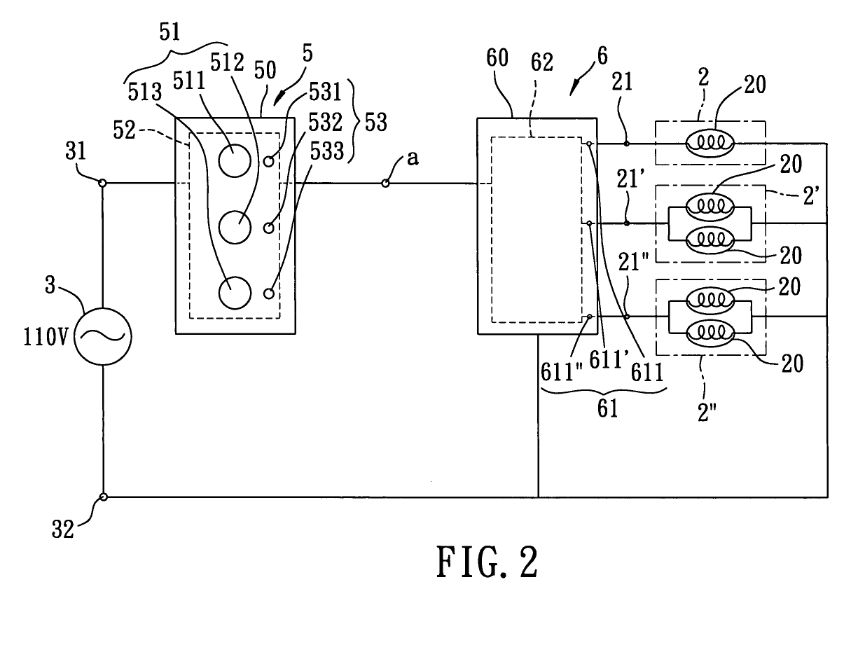

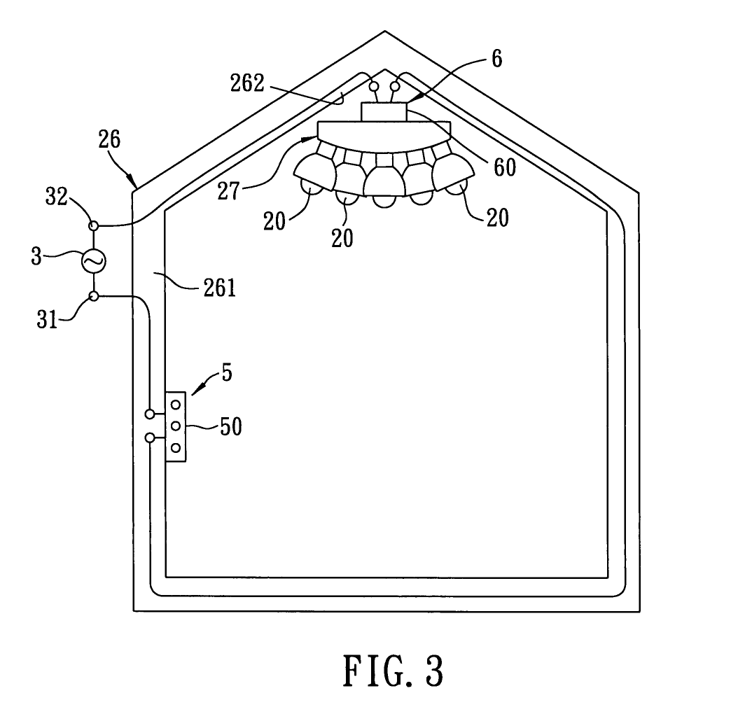

Referring to FIGS. 2 and 3, the preferred embodiment of a power control device according to the present invention is shown to be adapted for controlling supply of electric power from a power source 3 to a plurality of load terminals 21, 21′, 21″ in various control modes, and includes a first circuit module 5 and a second circuit module 6. In this embodiment, the power control device is applied for controlling a lamp device 27 mounted on a ceiling 262 of a building 26 using pre-installed wiring in the building 26, as shown in FIG. 3. The lamp device 27 includes a plurality of load units 2, 2′, 2″ connected respectively to the load terminals 21, 21′, 21″, wherein the load unit 2 has a lamp 20, and each of the load units 2′, 2″ has two lamps 20 connected in parallel to each other. In this embodiment, the power source 3 is an alternating current (AC) power source that can provide an AC power of 110V with 60 Hz as the electric power, and is connected across two nodes 31, 32.

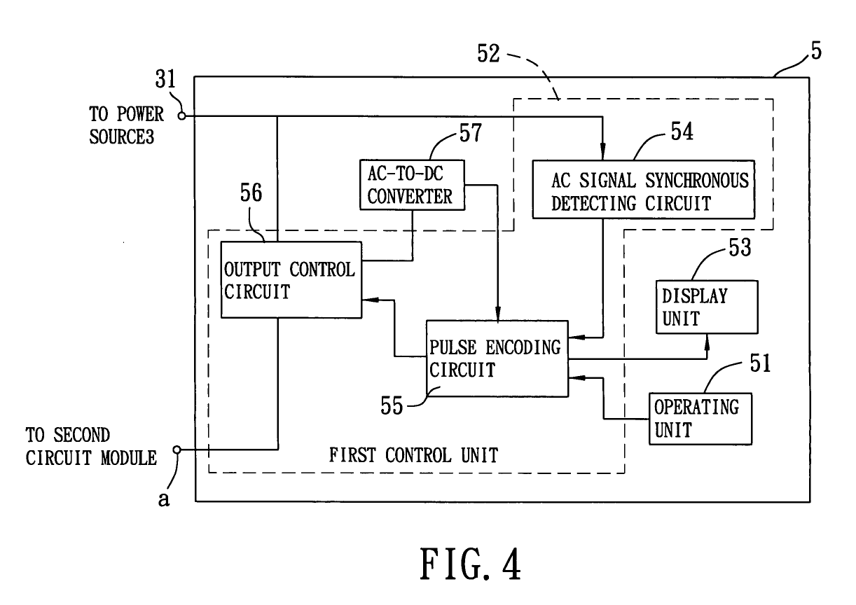

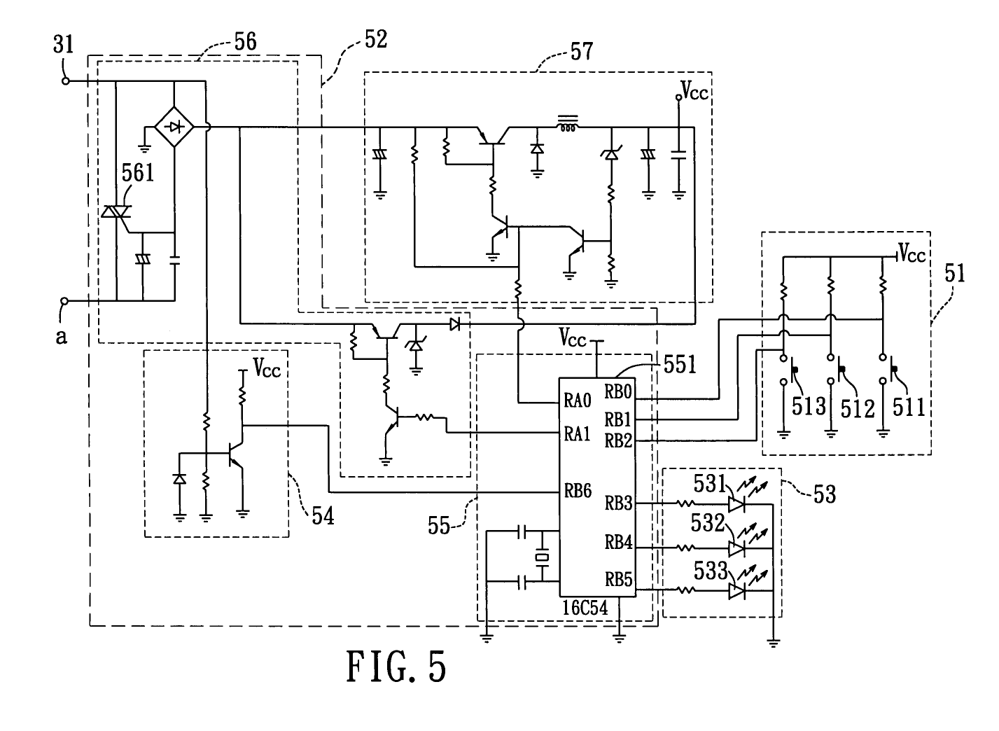

With further reference to FIGS. 4 and 5, the first circuit module 5 includes a first housing 50, an operating unit 51, a first control unit 52, a display unit 53, and an AC-to-DC converter 57.

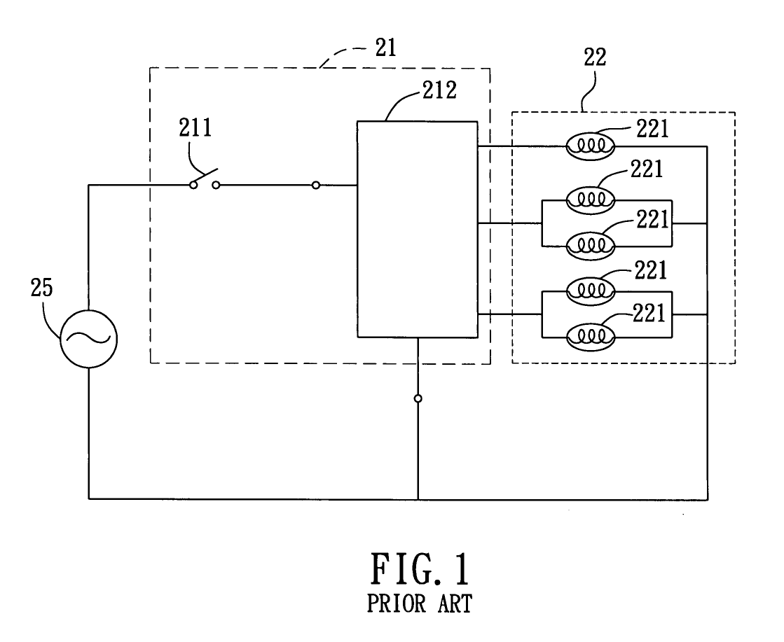

The first housing 50 is adapted to be mounted on a wall 261 of the building 26 (see FIG. 3) and can be designed to have the same size as that of the switch unit 211 of the aforesaid conventional switch control device 21 shown in FIG. 1.

The operating unit 51 is mounted on the first housing 50, and includes a plurality of operating keys 511, 512, 513, each of which is operable so as to generate an input signal associated with a corresponding one of the control modes.

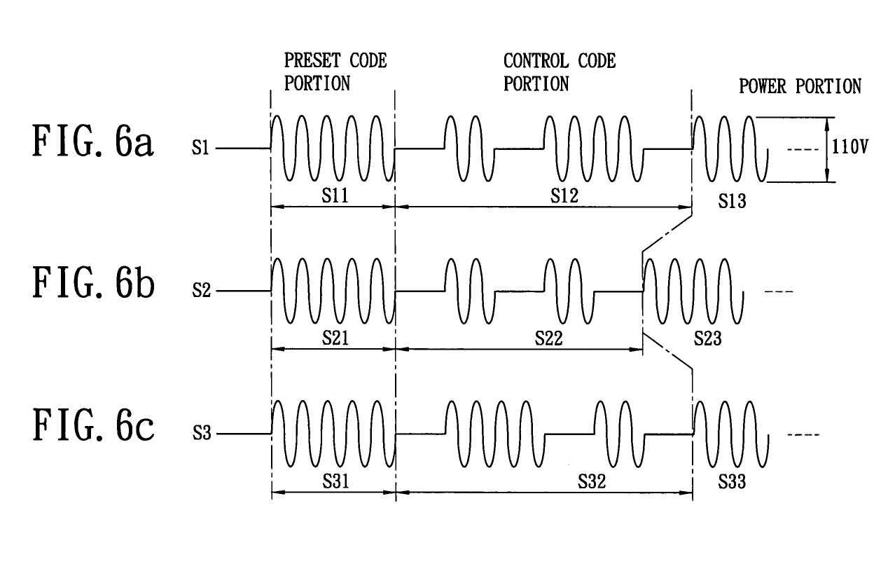

The first control unit 52, which is disposed in the first housing 50, is adapted to be connected electrically to the power source 3 via the node 31 for receiving the electric power therefrom, and is connected electrically to the operating unit 51 for receiving the input signal therefrom so as to generate an encoded output signal (S1, S2, S3) that has a sequence of a preset code portion (S11, S21, S31), a distinct control code portion (S12, S22, S32) and a power portion (S13, S23, S33) (see FIGS. 6a to 6c). The distinct control code portion (S12, S22, S32) corresponds to the input signal. The power portion (S13, S23, S33) is equivalent to the electric power from the power source 3. In this embodiment, it is noted that each of the operating keys 511, 512, 513 of the operating unit 51 is further operable so as to enable the first control unit 52 to stop generating the corresponding encoded output signal (S1, S2, S3).

In this embodiment, the first control unit 52 includes an AC signal synchronous detecting circuit 54, a pulse encoding circuit 55, and an output control circuit 56. The AC signal synchronous detecting circuit 54 is adapted to be connected electrically to the power source 3 via the node 31 for receiving and detecting the electric power therefrom and for generating a detecting output having logic-low components of the electric power. In this embodiment, as shown in FIG. 5, the pulse encoding circuit 55 includes a 16C54 IC 551 of which pins (RB0, RB1, RB2) are connected electrically and respectively to the operating keys 511, 512, 513 of the operating unit 51 for receiving the input signal from the operating unit 51, and a pin (RB6) is connected electrically to the AC signal synchronous detecting circuit 54 for receiving the detecting output therefrom. The pulse encoding circuit 55 generates a distinct encoded signal corresponding to the input signal, and outputs the distinct encoded signal at a pin (RA1) of the IC 551. The output control circuit 56 is connected electrically to the pulse encoding circuit 55 via the pin (RA1) of the IC 551 and is adapted to be connected electrically to the power source 3 via the node 31 for receiving the encoded signal and the electric power therefrom. In this embodiment, the output control circuit 56 generates the encoded output signal (S1, S2, S3) by controlling a TRIAC 561 thereof, and outputs the encoded output signal (S1, S2, S3) at a node (a). The control code portion (S12, S22, S23) of the encoded output signal (S1, S2, S3) corresponds to the encoded signal, and the power portion (S13, S23, S33) of the encoded output signal (S1, S2, S3) corresponds to the electric power from the power source 3.

The display unit 53 is connected electrically to the first control unit 52 for indicating operating states of the operating keys 511, 512, 513 of the operating unit 51. In this embodiment, the display unit 53 is mounted on the first housing 50, as shown in FIG. 2, and includes a plurality of light emitting diodes (LEDs) 531, 532, 533, each of which is disposed adjacent to a corresponding one of the operating keys 511, 512, 513 of the operating unit 51 for indicating the operating state of the corresponding one of the operating keys 511, 512, 513 of the operating unit 51. In this embodiment, the light emitting diodes 531, 532, 533 of the display unit 51 are connected electrically and respectively to pins (RB3, RB4, RB5) of the IC 551 of the pulse encoding circuit 55.

In this embodiment, the AC-to-DC converter 57 is connected electrically to the output control circuit 56 and the pulse encoding circuit 55 of the first control unit 52, and converts the electric power from the power source 3 through the output control circuit 56 into a DC power that is supplied to the pulse encoding circuit 55 via a pin (RA0) of the IC 551.

Referring further to FIGS. 5, and 6a to 6c, operation of the first circuit module 5 in the various modes is described in detail as follows:

1. When the operating key 511 of the operating unit 51 is operated, the pins (RB0, RB1, RB2) of the IC 551 receive respectively a logic-low input, a logic-high input and a logic-high input that serve as the input signal. Thus, the IC 551 outputs respectively a logic-high output, a logic-low output and a logic-low output at the pins (RB3, RB4, RB5) so that the LED 531 is activated while the LEDs 532, 533 are deactivated, and also outputs the encoded signal corresponding to the input signal to the output control circuit 56 via the pin (RA1) in response to the logic-low detecting output received from the AC signal synchronous circuit 54 via the pin (RB6). Subsequently, the encoded output signal (S1) is outputted by the output control circuit 56 at the node (a). For the encoded output signal (S1) shown in FIG. 6a, the preset code portion (S11) includes a periodic sine wave having 5 cycles, and the control code portion (S12) includes a sequence of a first periodic sine wave having 2 cycles, and a second periodic sine wave having 4 cycles. It is noted that there are respectively provided time intervals of 2 cycles, i.e., 2/60 sec, between the preset code portion (S11) and the first periodic sine wave of the control code portion (S12), between the first and second periodic sine waves of the control code portion (S12), and between the second periodic sine wave of the control code portion (S12) and the power portion (S13).

Furthermore, when the operating key 511 is further operated, the IC 551 further outputs a logic-low output at the pin (RB3) so that the LED 531 is deactivated, and the output control circuit 56 stops generating the encoded output signal (S1).

2. When the operating key 512 of the operating unit 51 is operated, the pins (RB0, RB1, RB2) of the IC 551 receive respectively a logic-high input, a logic-low input and a logic-high input that serve as the input signal. Thus, the IC 551 outputs respectively a logic-low output, a logic-high output and a logic-low output at the pins (RB3, RB4, RB5) so that the LED 532 is activated while the LEDs 531, 533 are deactivated, and also outputs the encoded signal corresponding to the input signal to the output control circuit 56 via the pin (RA1) in response to the logic-low detecting output received from the AC signal synchronous circuit 54 via the pin (RB6). Subsequently, the encoded output signal (S2) is outputted by the output control circuit 56 at the node (a). The encoded output signal (S2) shown in FIG. 6b differs from the encoded output signal (S1) shown in FIG. 6a in that the control code portion (S22) of the encoded output signal (S2) includes a sequence of a first periodic sine wave having 2 cycles, and a second periodic sine wave having 2 cycles.

Furthermore, when the operating key 512 is further operated, the IC 551 further outputs a logic-low output at the pin (RB4) so that the LED 532 is deactivated, and the output control circuit 56 stops generating the encoded output signal (S2).

3. When the operating key 513 of the operating unit 5 is operated, the pins (RB0, RB1, RB2) of the IC 551 receive respectively a logic-high input, a logic-high input and a logic-low input that serve as the input signal. Thus, the IC 551 outputs respectively a logic-low output, a logic-low output and a logic-high output at the pins (RB3, RB4, RB5) so that the LED 533 is activated while the LEDs 531, 532 are deactivated, and also outputs the encoded signal corresponding to the input signal to the output control circuit 56 via the pin (RA1) in response to the logic-low detecting output received from the AC signal synchronous circuit 54 via the pin (RB6). Subsequently, the encoded output signal (S3) is outputted by the output control circuit 56 at the node (a). The encoded output signal (S3) shown in FIG. 6c differs from the encoded output signal (S1) shown in FIG. 6a in that the control code portion (S32) of the encoded output signal (S3) includes a sequence of a first periodic sine wave having 4 cycles, and a second periodic sine wave having 2 cycles.

Furthermore, similar to the operation of the operating key 511, when the operating key 513 is further operated, the IC 551 further outputs a logic-low output at the pin (RB5) so that the LED 533 is deactivated, and the output control circuit 56 stops generating the encoded output signal (S3).

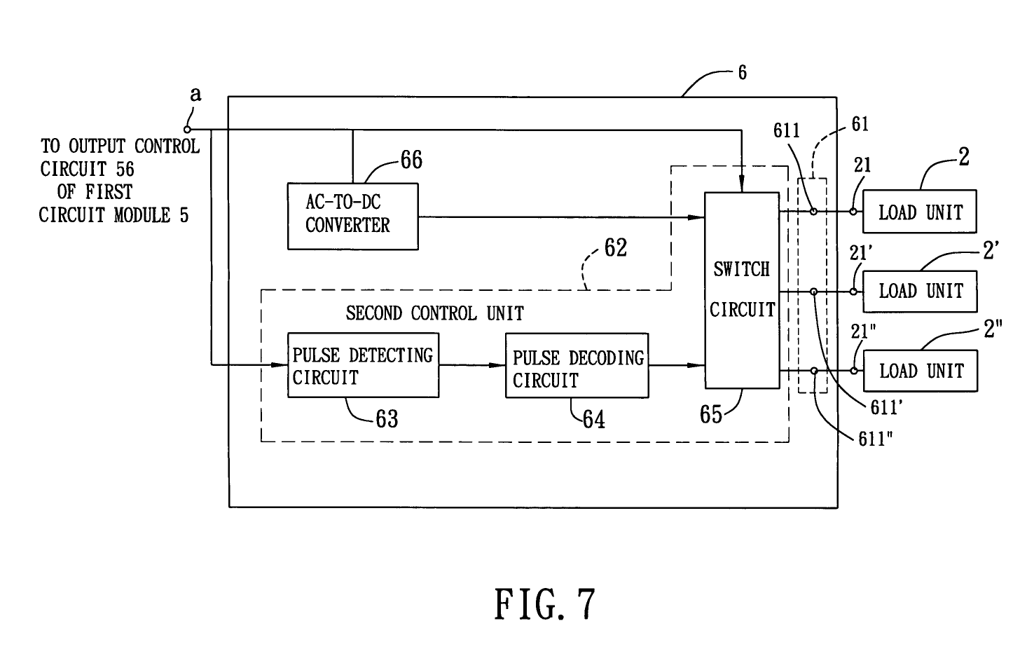

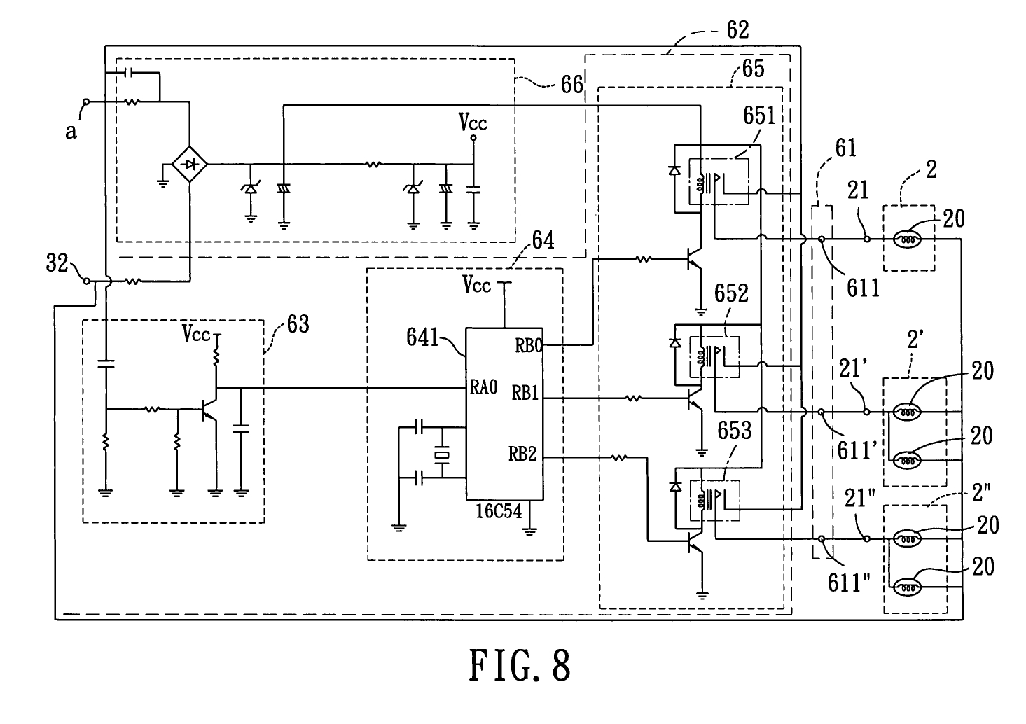

With further reference to FIGS. 2, 7 and 8, the second circuit module 7 includes a second housing 60, an output end unit 61, a second control unit 62, and an AC-to-DC converter 66.

In this embodiment, the second housing 60 is adapted to be mounted on the lamp device 27, as shown in FIG. 3.

In this embodiment, the output end unit 61 is mounted on the second housing 60, and includes three output ends 611, 611′, 611″ adapted to be connected electrically to the load terminals 21, 21′, 21″.

The second control unit 62 is disposed in the second housing, and is connected electrically to the first control unit 52 of the first circuit module 5 and the output end unit 61 (see FIG. 2). The second control unit 62 receives the encoded output signal (S1, S2, S3) from the first control unit 52 of the first circuit module 5, and supplies the power portion (S13, S23, S33) of the encoded output signal (S1, S2, S3) via the output end unit 61 to a combination of the load terminals 21, 21′, 21″ that corresponds to the control code portion (S12, S22, S32) of the encoded output signal (S1, S2, S3).

In this embodiment, the second control unit 62 includes a pulse detecting circuit 63, a pulse decoding circuit 64, and a switch circuit 65. The pulse detecting circuit 63 is connected electrically to the output control circuit 56 of the first control unit 52 via the node (a), detects the encoded output signal (S1, S2, S3) from the output control circuit 56 of the first control unit 52, and generates a detecting signal corresponding to the control code portion (S12, S22, S32) of the encoded output signal (S1, S2, S3). In this embodiment, the pulse decoding circuit 64 includes a 16C54 IC 641 of which a pin (RA0) is connected electrically to the pulse detecting circuit 63 for receiving the detecting signal therefrom. The IC 641 decodes the detecting signal received at the pin (RA0), generates a decoded signal corresponding to the control code portion (S12, S22, S32) of the encoded output signal (S1, S2, S3), and outputs the decoded signal at pins (RB0, RB1, RB2) thereof. The switch circuit 65 is connected electrically to the output control circuit 56 of the first control unit 52 via the node (a), the pulse decoding circuit 64 and the output end unit 61. In this embodiment, the switch circuit 65 includes three relay-type switch units 651, 652, 653, each of which is connected electrically among the node (a), a corresponding one of the pins (RB0, RB1, RB2) of the IC 16C54 641 of the pulse decoding circuit 64, and a corresponding one of the output ends 611, 611′, 611″ of the output end unit 61. The switch circuit 65 controls electrical connection between the output control circuit 56 of the first control unit 52 and each of the output ends 611, 611′, 611″ of the output end unit 61 in response to the decoded signal from the pulse decoding circuit 64 such that the power portion (S13, S23, S33) of the encoded output signal (S1, S2, S3) from the output control circuit 56.of the first control unit 52 is able to be supplied to the preset combination of the load terminals 21, 21′, 21″ that corresponds to the control code portion (S12, S22, S32) of the encoded output signal (S1, S2, S3).

In this embodiment, the AC-to-DC converter 66 is connected electrically to the output control circuit 56 of the first circuit unit 52 via the node (a), and the switch circuit 65, and converts the electric power from the power source 3, i.e., the power portion (S13, S23, S33) of the encoded output signal (S1, S2, S3), into a DC power that is supplied to each of the switch units 651, 652, 653 of the switch circuit 65.

Based on the aforesaid operations of the first circuit module 5, various control results of the switch circuit 65 are described in detail as follows:

1. When the encoded output signal (S1) (see FIG. 6a) due to the operation of the operating key 511 (see FIG. 5) of the operating unit 51 is received by the pulse detecting circuit 63, the decoded signal thus generated by the pulse decoding circuit 64 corresponds to the control code portion (S12) of the encoded output signal (S1), and enables only the switch unit 651 to be excited such that the power portion (S13) of the encoded output signal (S1) is supplied to the load terminal 21, thereby activating the load unit 2. Furthermore, when the operating key 511 is further operated, since the encoded output signal (S1) is no longer generated, none of the switch units 651, 652, 653 can be excited such that the electric power from the power source 3 is not supplied to each of the load terminals 21, 21′, 21″.

2. When the encoded output signal (S2) (see FIG. 6b) due to the operation of the operating key 512 (see FIG. 5) of the operating unit 51 is received by the pulse detecting circuit 63, the decoded signal thus generated by the pulse decoding circuit 64 corresponds to the control code portion (S22) of the encoded output signal (S2), and enables the switch units 651, 652 to be excited such that the power portion (S23) of the encoded output signal (S2) is supplied to the load terminals 21, 21′, thereby activating the load units 2, 2′. Furthermore, when the operating key 512 is further operated, since the encoded output signal (S2) is no longer generated, none of the switch units 651, 652, 653 can be excited such that the electric power from the power source 3 is not supplied to each of the load terminals 21, 21′, 21″.

3. When the encoded output signal (S3) (see FIG. 6c) due to the operation of the operating key 513 (see FIG. 5) of the operating unit 51 is received by the pulse detecting circuit 63, the decoded signal thus generated by the pulse decoding circuit 64 corresponds to the control code portion (S32) of the encoded output signal (S3), and enables the switch units 651, 652, 653 to be excited such that the power portion (S33) of the encoded output signal (S3) is supplied to the load terminals 21, 21′, 21″, thereby activating the load units 2, 2′, 2″. Furthermore, when the operating key 513 is further operated, since the encoded output signal (S3) is no longer generated, none of the switch units 651, 652, 653 can be excited such that the electric power from the power source 3 is not supplied to each of the load terminals 21, 21′, 21″.

In such a configuration, by operating one of the operating keys 511, 512, 513 of the operating unit 51, a corresponding number of the lamps 20 of the lamp device 27 can be activated. On the other hand, by further operating the selected operating key 511, 512, 513 of the operating unit 51, the corresponding number of the lamps 20 of the lamp device 27 can be deactivated. Therefore, the power control device of the invention can facilitate activation of the lamp device 27 in various control modes as compared to the conventional power control device. Furthermore, since the first circuit module 5 has a size similar to the switch unit 211 of the aforesaid conventional switch control device 21 shown in FIG. 1, and since the power control device can be used with the original electrical wiring arrangement in buildings, the power control device of the invention can be used to easily and directly replace the aforesaid conventional switch control device.

It is noted that the power control device of the present invention can also be applied to a ceiling fan device for selecting a desired one of various rotary speed settings through operation of a selected one of the operating keys 511, 512, 513 of the operating unit 51, by connecting electrically and respectively the load terminals 21, 21′, 21″ to three motor coils (not shown) of the ceiling fan device that correspond respectively to high, medium and low rotary speeds, at relatively low costs as compared to a conventional wireless remote control device for a ceiling fan device.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A power control device for controlling supply of electric power from a power source to a plurality of load terminals in various control modes, said power control device comprising:
a first circuit module including
an operating unit including a plurality of operating keys, each of which is operable so as to generate an input signal associated with a corresponding one of the control modes, and
a first control unit adapted to be connected electrically to the power source for receiving the electric power therefrom, and connected electrically to said operating unit for receiving the input signal therefrom so as to generate an encoded output signal that includes a distinct control code portion corresponding to the input signal, and a power portion equivalent to the electric power from the power source; and
a second circuit module including
an output end unit adapted to be connected electrically to the load terminals, and
a second control unit connected electrically to said first control unit of said first circuit module and said output end unit, said second control unit receiving the encoded output signal from said first control unit of said first circuit module and supplying the power portion of the encoded output signal via said output end unit to a combination of the load terminals that corresponds to the control code portion of the encoded output signal.

2. The power control device as claimed in claim 1, wherein:
said first circuit module further includes a first housing housed with said first control unit, said operating unit being mounted on said first housing; and
said second circuit module further includes a second housing housed with said second control unit.

3. The power control device as claimed in claim 1, wherein each of said operating keys of said operating unit is further operable so as to enable said first control unit to stop generating the encoded output signal.

4. The power control device as claimed in claim 3, wherein said first circuit module further includes a display unit connected to said first control unit for indicating operating states of said operating keys of said operating unit.

5. The power control device as claimed in claim 4, wherein:
said first circuit module further includes a first housing housed with said first control unit, said operating unit and said display unit being mounted on said first housing;
said display unit includes a plurality of light emitting diodes, each of which is disposed adjacent to a corresponding one of said operating keys of said operating unit for indicating the operating state of the corresponding one of said operating keys of said operating unit; and
said second circuit module further includes a second housing housed with said second control unit.

6. The power control device as claimed in claim 1, the power source being an alternating current (AC) power source, wherein said first control unit includes:
an AC signal synchronous detecting circuit adapted to be connected electrically to the power source for receiving and detecting the electric power therefrom and for generating a detecting output having logic-low components of the electric power;
a pulse encoding circuit connected electrically to said operating unit and said AC signal synchronous detecting circuit for receiving the input signal and the detecting output therefrom and for generating a distinct encoded signal corresponding to the input signal; and
an output control circuit connected electrically to said pulse encoding circuit and adapted to be connected electrically to the power source for receiving the encoded signal and the electric power therefrom, said output control circuit generating the encoded output signal that includes the control code portion corresponding to the encoded signal, and the power portion corresponding to the electric power from the power source.

7. The power control device as claimed in claim 6, wherein said second control unit includes:
a pulse detecting circuit connected electrically to said output control circuit of said first control unit, said pulse detecting circuit detecting the encoded output signal from said output control circuit of said first control unit and generating a detecting signal corresponding to the control code portion of the encoded output signal;
a pulse decoding circuit connected electrically to said pulse detecting circuit, said pulse decoding circuit decoding the detecting signal from said pulse detecting circuit and generating a decoded signal corresponding to the control code portion of the encoded output signal; and
a switch circuit connected electrically to said output control circuit of said first control unit, said pulse decoding circuit and said output end unit, said output end unit including a plurality of output ends adapted to connected electrically and respectively to the load terminals, said switch circuit controlling electrical connection between said output control circuit of said first control unit and each of said output ends of said output end unit in response to the decoded signal from said pulse decoding circuit such that the power portion of the encoded output signal from said output control circuit of said first control unit is able to be supplied to the preset combination of the load terminals that corresponds to the control code portion of the encoded output signal.

8. The power control device as claimed in claim 7, wherein:
said first circuit module further includes an AC-to-DC converter for converting the electric power from the power source into a DC power that is supplied to said first control unit; and
said second circuit module further includes an AC-to-DC converter for converting the electric power from the power source into a DC power that is supplied to said second control unit.

9. A circuit module for generating distinct encoded output signals from a power source to control supply of electric power from a power source to a plurality of load terminals in various control modes, said circuit module comprising:
a hollow housing;
an operating unit mounted on said housing and having a plurality of operating keys, each of which is operable so as to generate an input signal associated with a corresponding one of the control modes; and
a control unit mounted in said housing, adapted to be connected electrically to the power source for receiving the electric power therefrom, and connected electrically to said operating unit for receiving the input signal therefrom so as to generate a corresponding one of the encoded output signals that includes a distinct control code portion corresponding to the input signal, and a power portion equivalent to the electric power from the power source.

10. A circuit module for controlling supply of electric power to a plurality of load terminals in various control modes and in response to an encoded output signal that is received thereby and that has a distinct control code portion associated with a corresponding one of the control modes, and a power portion equivalent to the electric power, said circuit module comprising:
a hollow housing;
an output end unit mounted on said housing and adapted to be connected electrically to the load terminals; and
a control unit mounted in said housing, connected electrically to said output end unit, adapted for receiving the encoded output signal, and supplying the power portion of the encoded output signal via said output end unit to a combination of the load terminals that corresponds to the control code portion of the encoded output signal.
